(19) United States
(12) Patent Application Publication
(10) Pub. No.: US 2008/0202279 A1
(43) Pub. Date: Aug. 28, 2008

(54) Pedal Arrangement for a Motor Vehilce

(76) Inventors: Andree Burgstaler, Dielingen (DE); Jan Dutz, Damme (DE); Wolfgang Meyer, Osnabruck (DE); Silke Hulsmann, Ankum (DE)

Correspondence Address: MCGLEW & TUTTLE, PC, P.O. BOX 9227, SCARBOROUGH STATION, SCARBOROUGH, NY, 10510-9227, US

(21) Appl. No.: 11/917,558

(22) PCT Filed: Jun. 14, 2006
(86) PCT No.: PCT/DE2006/001020

§ 371 Date: Dec. 14, 2007

(30) Foreign Application Priority Data
Jun. 17, 2005 (DE) 10 2005 028 514.7

(51) Int. Cl. B60K 26/00; G05G 1/30

(52) U.S. Cl. 74/513; 74/560

(57) ABSTRACT

A pedal arrangement is provided for a motor vehicle with a bracket (2) and with an E-gas module (3) fastened thereto via a plug-in connection. The an E-gas module (3) has a pedal bearing (29), on which a gas pedal (11) is mounted pivotably about a pivot axis (12), wherein a structural unit that is independent from the bracket (2) is formed by the E-gas module (3).

### CROSS REFERENCE TO RELATED APPLICATIONS

This application is a United States National Phase application of International Application PCT/DE 2006/001020 and claims the benefit of priority under 35 U.S.C. § 119 of German Patent Application DE 10 2005 028 514.7 filed Jun. 17, 2005, the entire contents of which are incorporated herein by reference.

### FIELD OF THE INVENTION

The present invention pertains to a pedal arrangement for a motor vehicle, with a bracket and with an E-gas module fastened to same via a plug-in connection with a pedal bearing, at which a gas pedal is mounted pivotably about a pivot axis.

### BACKGROUND OF THE INVENTION

Prior-art E-gas modules are connected, e.g., by screw connections (mostly three) to the vehicle body or the pedal block. It is possible as a result to mount and remove these E-gas modules as often as desired. In addition, a fastening is embodied that makes possible the force transmission to the vehicle body or the pedal block without problems. Furthermore, this type of fastening was standardized for various model series of the vehicle manufacturers.

The prior-art fastenings of E-gas modules are, however, cost- and mounting-intensive, because three fastening points are usually provided with bushings, screws and/or nuts. Furthermore, these components cause extra costs because of the logistics associated therewith. Furthermore, these components may contribute to the overall weight of the pedal arrangement to a rather substantial extent. Finally, the metallic components (screws, bushings, nuts) are to be removed in case of reuse, which increases the effort and hence the costs for reuse.

An accelerator module for an engine is known from DE 101 35 537 A1, where a sensor is provided to detect the position of a pedal lever in relation to a mounting plate, which is used for the pivotable mounting of the pedal lever. The position sensor is designed as an independent assembly unit, which is attached to the mounting plate, the sensor being received in a housing. A bearing block, which forms a stationary component of the pedal lever bearing, is made integrally in one piece with a broad side of the mounting plate. The sensor housing has a rail-like foot, which is pushed in, in a holding groove formed on the mounting plate in parallel to the axis of rotation. The holding groove is axially open for this purpose on a broad side of the mounting plate on the side located opposite the bearing block. It has a T-shaped cross-sectional profile, which surrounds the foot of the sensor housing in a positive-locking manner, so that this foot is displaceable in the direction parallel to the axis of rotation, but is otherwise fixed.

The sensor and the pedal bearing form an E-gas module here, which can be assembled from its individual parts directly at the mounting plate or bracket. The module must also be taken apart into its individual parts at the site of the mounting plate in case of removal of the E-gas module from the bracket.

### SUMMARY OF THE INVENTION

The object of the present invention is to perfect a pedal arrangement of the type mentioned in the introduction such that the mounting and optionally also the removal of the E-gas module on or from the bracket is simplified.

The pedal arrangement according to the present invention for a motor vehicle has a bracket and an E-gas module fastened to same via a plug-in connection, especially in a positive-locking manner, with a pedal bearing, at which a gas pedal is mounted pivotably about a pivot axis, the E-gas module forming a structural unit independent from the bracket.

Thus, it is possible in the pedal arrangement according to the present invention to plug the E-gas module as an independent and completely assembled unit onto the bracket, as a result of which the mounting of the E-gas module on the bracket is simplified. An E-gas module shall be defined here especially as an independent structural unit, which has at least a pedal bearing and preferably also a sensor, which can detect the pivoting motions of the gas pedal relative to the pedal bearing or the bracket. The pedal bearing, which is preferably designed as a drag bearing, and optionally also the sensor are thus integral components of the structural unit independent from the bracket, which unit is formed by the E-gas module. The pedal bearing and optionally the sensor are seated, preferably together, in or on a housing of the E-gas module.

Furthermore, electric connections or lines from the E-gas module may extend up to a control device, which can analyze signals detected by the sensor and actuate the engine of a motor vehicle corresponding to the detected pivoted position of the gas pedal. To connect the E-gas module electrically separately to the control device, a plug type connection may be provided, whose socket or plug is preferably provided on the E-gas module or on the housing and is electrically connected to the sensor. The E-gas module can thus be designed from an electrical point of view as a structural unit separable from the motor vehicle or the control device.

The E-gas module is fastened to the bracket preferably detachably via the plug-in connection and can be separated from the bracket as a structural unit, especially together with the gas pedal. However, the plug-in connection may at the same time form a clamped connection, which fixes the E-gas module on the bracket in a non-positive manner in addition to the positive-locking plug-in connection, in order to prevent the E-gas module from accidentally separating from the bracket. However, it is also possible, as an alternative or in addition to the clamped connection, to secure the E-gas module at the bracket by means of a snap-in connection, which is preferably designed as a detachable snap-in connection.

A first holding groove and a first foot, which is plugged into same and which meshes with the first holding groove in a positive-locking manner, may be provided to embody the plug-in connection. The first holding groove thus forms a guide for the first foot, in which guide this foot is guided displaceably for the purpose of mounting and removal and is held, in particular, at right angles to the direction of displacement in a positive-locking manner. The first holding groove extends especially at right angles to the pivot axis, so that the first foot is plugged or pushed into the first holding groove at right angles hereto. Due to the first holding groove extending at right angles to the axis of rotation or pivot axis, torques acting on the E-gas module can be absorbed simply and reliably. As an alternative, the first holding groove may, however, also extend in parallel to the pivot axis, so that the first foot is plugged or pushed into the first holding groove in parallel to this.

If the pedal arrangement is installed in a motor vehicle, the first holding groove extends especially from “top” to “bottom,” and the first foot or the E-gas module is preferably plugged or pushed in from “top” to “bottom.” Furthermore, in the mounted state, the E-gas module may be in contact with a stop, which limits a further displacement of the first foot or of the E-gas module, especially “downwardly.” The mounting direction pointing “downwardly” represents a certain self-securing for the E-gas module, so that the latter cannot become separated from the bracket by itself or due to vibrations. The terms “top” and “bottom” shall be seen here in connection with the gravitational field of the earth. The intrinsic weight of the E-gas module thus ensures the firm cohesion of the E-gas module and the bracket, and this cohesion can be supplementarily enhanced by means of the snap-in connection, which is additionally possible.

At least one projection, which meshes with at least one undercut provided in the first holding groove, is preferably provided on the first foot. Furthermore, the first holding groove has especially an insertion area as well as a meshing area with the undercut, which areas are meshed by the projection provided on the first foot, the groove opening of the insertion area being larger than the groove opening of the meshing area. For mounting, the first foot with its projection can be inserted into the holding groove through the groove opening of the insertion area and then pushed along same into the meshing area, preferably at right angles to the pivot axis, so that reliable cohesion of the E-gas module and the bracket is guaranteed by the projection meshing with the undercut. The insertion area and the meshing area preferably pass over into one another for this purpose. Furthermore, the groove opening of the insertion area is especially so large that the first foot with its projection can also be inserted through these into the first holding groove. The groove opening of the insertion area at right angles to the plugging-in direction and/or in parallel to the pivot axis may be larger for this purpose than the groove opening of the meshing area, so that especially the width of the groove opening of the insertion area at right angles to the plugging-in direction is greater than the width of the groove opening of the meshing area at right angles to the plugging-in direction. Furthermore, the meshing area and the insertion area are preferably arranged next to each other, e.g., in a direction at right angles to the pivot axis.

The first holding groove and the first foot may have, at least in some areas, a T-shaped cross section, so that the T-shaped area of the first foot meshes with the T-shaped recess of the first holding groove in a positive-locking manner. The plane of symmetry of these T-shaped cross sections preferably extends at right angles to the pivot axis. When the first holding groove extends at right angles to the pivot axis, the first foot with its T-shaped area can be displaced in a direction at right angles to the axis of rotation in the first holding groove and in the T-shaped area of the first holding groove for mounting and optionally also for removing the E-gas module on or from the bracket.

It is possible, in principle, to form the first holding groove on the E-gas module and the first foot on the bracket. However, the first foot is preferably provided at the E-gas module and the first holding groove at the bracket, in which case the first foot can be manufactured in one piece with the housing of the E-gas module, e.g., from a plastic.

In addition, the plug-in connection may have a second holding groove at a spaced location from the first holding groove and a second foot, which is plugged into the second holding groove and especially meshes with same in a positive-locking manner, at a spaced location from the first foot. A relatively short mounting path is thus possible compared to a single, long groove or a single, long foot, so that rapid and reliable mounting can be achieved and jamming between the holding groove and the foot hardly ever occurs in practice if at all. The second holding groove preferably extends at right angles to the pivot axis, so that the second foot is plugged or pushed into the second holding groove at right angles to the pivot axis. As an alternative, the second holding groove may, however, also extend in parallel to the pivot axis, so that the second foot is plugged or pushed into the second holding groove in parallel to same. The second holding groove forms a guide for the second foot, in which the foot is guided displaceably, especially at right angles to the pivot axis, for mounting or removing, and is preferably held in a positive-locking manner at right angles to the direction of displacement. Furthermore, the first holding groove and the second holding groove lie especially on a common straight line.

The two feet are preferably provided at the E-gas module and the two holding grooves at the bracket, and the second foot may be manufactured, e.g., in one piece with the housing of the E-gas module, e.g., from a plastic. As an alternative, the holding grooves may, however, also be provided at the E-gas module and the feet may be provided at the bracket.

The second holding groove is preferably closed on its front side facing the first holding groove, so that this closed front side can form a stop up to which the second foot can be pushed into the second holding groove. Such a stop is used, on the one hand, as an additional securing means, but, on the other hand, also as a mounting aid. Furthermore, the second holding groove may be open on its front side facing away from the first holding groove, so that the second foot can be pushed or plugged into the second holding groove through this open front side. It is also possible to make the first holding groove open on its front side facing away from the second holding groove.

If the E-gas module and the bracket are connected to one another not only via a plug-in connection but additionally also via a snap-in connection, the plug-in connection may additionally have a snap hook and a recess, which is meshed with by the snap hook. The second foot may have the snap hook, which meshes with the recess provided in the bracket or the E-gas module, the snap hook being arranged especially at the end of the second foot facing away from the first foot. The snap hook and the recess form the above-mentioned snap-in connection, which is designed especially as a detachable snap-in connection.

At least one projection, which meshes with at least one undercut provided in the second holding groove, is preferably provided at the second foot. In particular, the second holding groove and the second foot may have, at least in some areas, a T-shaped cross section, so that the T-shaped area of the second foot meshes with the T-shaped recess of the second holding groove in a positive-locking manner. The plane of symmetry of these T-shaped cross sections preferably extends at right angles to the pivot axis. When the second holding groove extends at right angles to the pivot axis, the second foot with its T-shaped area can be displaced in a direction at right angles to the axis of rotation in the second holding groove or in the T-shaped area of the second holding groove for mounting and optionally also for removing the E-gas module on or from the bracket.

It is possible with the pedal arrangement according to the present invention to embody a fixing of the E-gas module on the bracket, this fixing making possibly do without additional fastening components. Especially the properties of plastics as a material are utilized, and the bracket and/or the housing of the E-gas module including the plug-in connection and optionally the snap-in connection can be manufactured from a plastic. The body (or housing) of the E-gas module may be designed such that it is connected to the pedal module, especially pushed in or turned in, on the side facing the pedal by means of the plug-in or clamping connection. The stronger resulting forces can now be expected on the side facing the pedal (e.g., in the area of the first foot). By contrast, non-positive locking and positive locking can likewise be achieved on the side facing away from the pedal (e.g., in the area of the second foot) by means of the plug-in connection. Furthermore, it is possible to embody here a securing against the E-gas module slipping out. No testing in which the E-gas module is loaded in this direction of force is known from the practice of automobile manufacturers.

In particular, the following advantages can be achieved with the pedal arrangement according to the present invention:

Fixing of the E-gas module on the bracket without additional fastening elements.

Facilitation of the mounting of the E-gas module on the bracket due to the plug-in solution created by the plug-in connection.

Weight reduction due to the fact that fastening elements, e.g., bolts, screws or nuts are no longer necessary.

Cost saving due to simple mounting and the possible elimination of fastening elements.

Possibility of removal without an additional tool.

Removal may be able to be repeated as often as possible, because preferably no thread-forming screws are used.

Complicated removal of the E-gas module can be avoided in case of reuse because no metal parts, e.g., bushings, screws or nuts have preferably been used.

Furthermore, the present invention pertains to a motor vehicle with a pedal arrangement, in which the pedal arrangement is fastened to the vehicle body, especially to the firewall separating the passenger compartment from the engine compartment. The pedal arrangement is a pedal arrangement according to the present invention, which may be varied according to all the above-mentioned embodiments.

The present invention will be described below on the basis of a preferred embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of an embodiment of the pedal arrangement according to the present invention;

FIG. 2 is a first schematic sectional view of the pedal arrangement according to FIG. 1;

FIG. 3 is a second schematic sectional view of the pedal arrangement according to FIG. 1;

FIG. 4 is a third schematic sectional view of the pedal arrangement according to FIG. 1;

FIG. 5 is a perspective view of the E-gas module according to FIG. 1; and

FIG. 6 is a perspective view of the bracket according to FIG. 1 without E-gas module.

### DESCRIPTION OF THE PREFERRED EMBODIMENTS

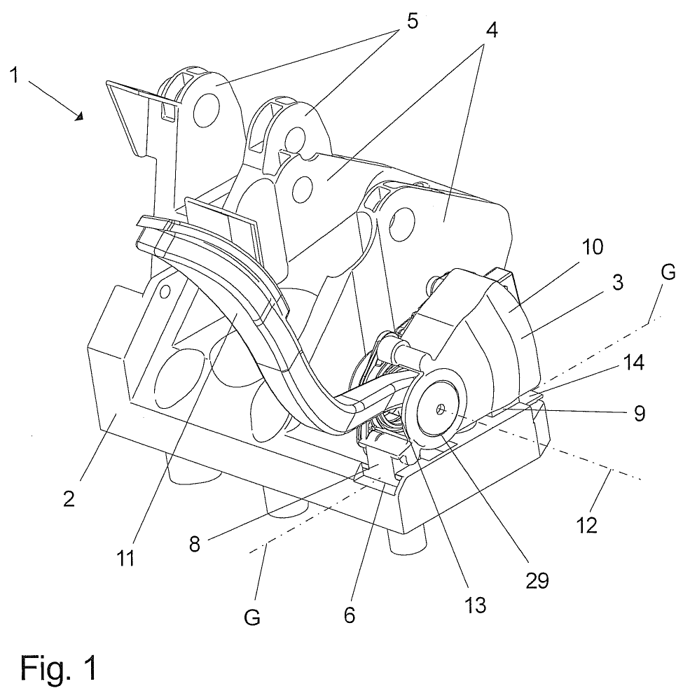

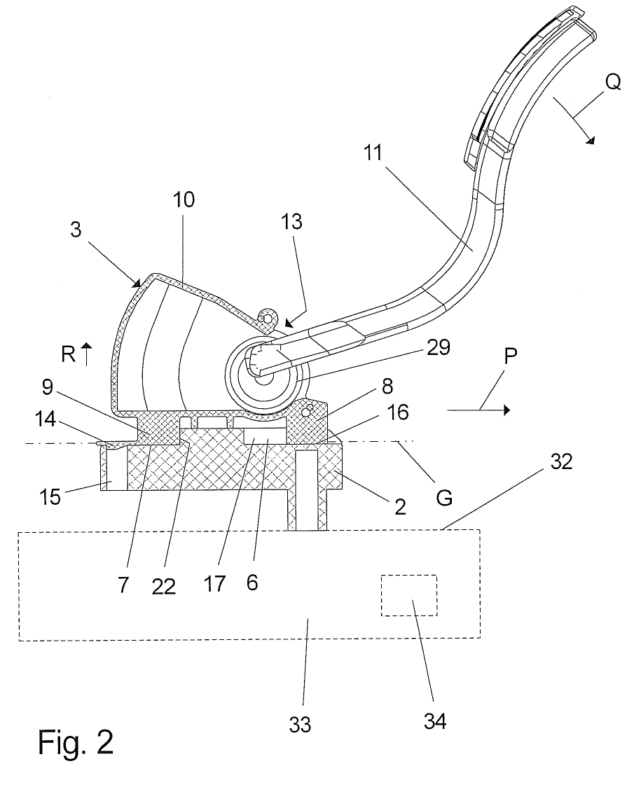

Referring to the drawings in particular, FIG. 1 shows a perspective view of an embodiment of the pedal arrangement 1 according to the present invention, in which an E-gas module 3 is fastened to a pedal block (bracket) 2. The pedal block 2 is used as a bracket for the E-gas module 3 and is provided, furthermore, with mounts 4 and 5 for a brake pedal, not shown, and a clutch pedal, likewise not shown. In an automatic variant of the pedal arrangement, which is not shown here, the mount 5 for the clutch pedal may, of course, be eliminated. The pedal block 2 is manufactured as a one-piece injection molding consisting of a plastic and has two holding grooves 6 and 7 (see FIG. 2), which are meshed with by two feet 8 and 9 provided at the E-gas module 3. The E-gas module 3 is provided with a housing 10, which is manufactured from a plastic and with which the feet 8 and 9 are made in one piece. Furthermore, a gas pedal 11 is mounted at a pedal bearing 29 in such a way that it is pivotable about a pivot axis 12 in the pedal bearing 29 of the E-gas module 3 and passes through an opening 13 and into the housing 10 of the E-gas module 3. The grooves 6 and 7 as well as the feet 8 and 9 lie on a straight line G, which extends at right angles to the pivot axis 12.

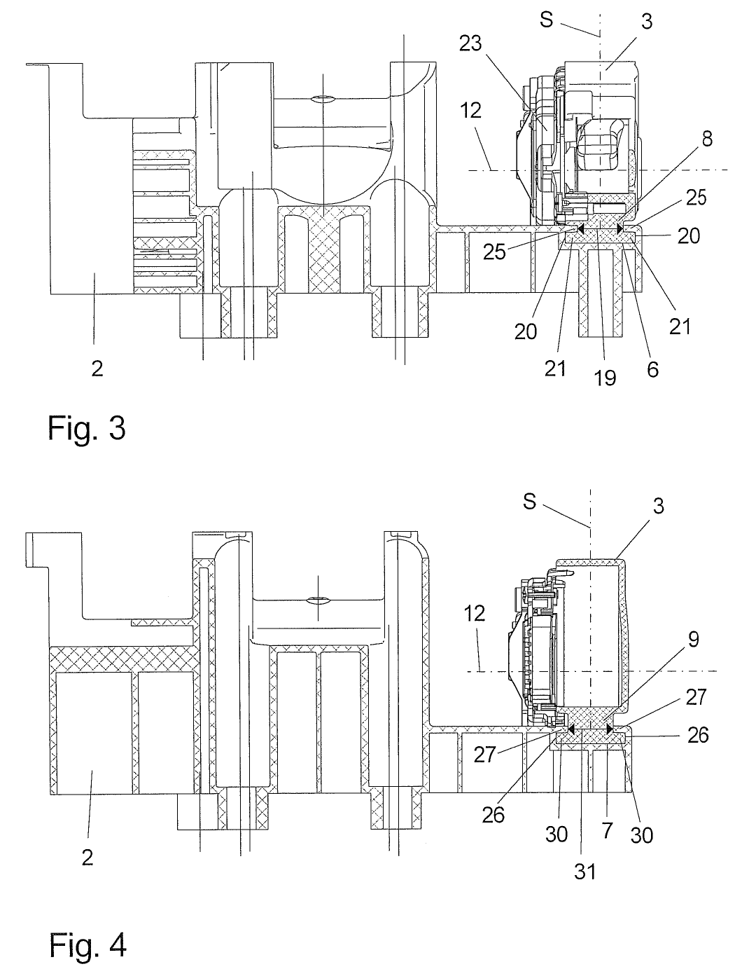

FIGS. 2 through 4 show different sectional views of the pedal arrangement 1, FIG. 2 showing a section along the straight line G and at right angles to the straight line 12. FIG. 3 shows a section passing through the foot 8 in parallel to the straight line 12 and at right angles to the straight line G. Furthermore, FIG. 4 shows a section passing through the foot 9 in parallel to the straight line 12 and at right angles to the straight line G.

A snap hook 14, which meshes with a recess 15 provided in the pedal block 2 and is made in one piece with the foot 9 from a plastic, is arranged at the foot 9. The snap hook 14 likewise lies on the straight line G and is provided at the end of the foot 9 facing away from the foot 8.

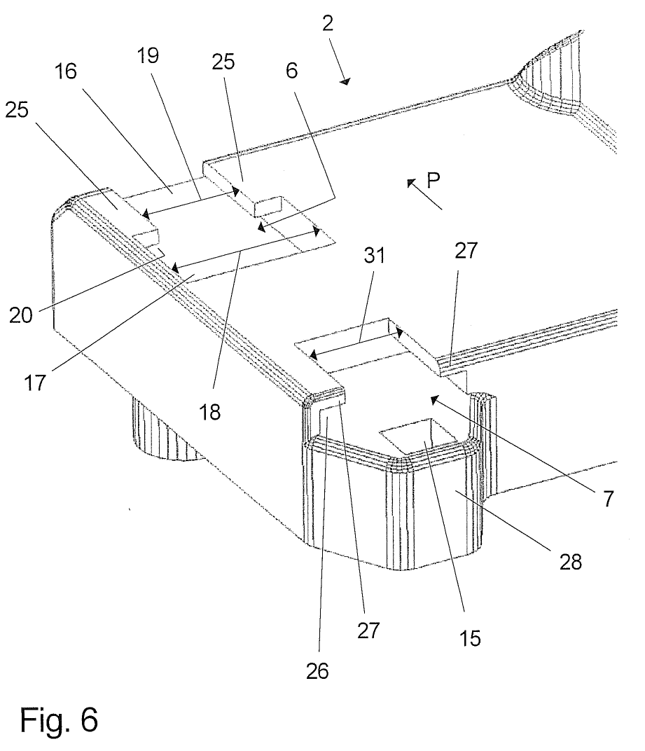

The groove 6 has a meshing area 16 and an insertion area 17, whose groove opening 18 (see FIG. 6) is large enough for the foot 8 to be able to be inserted through the groove opening 18 into the groove 6 for mounting the E-gas module 3 on the pedal block 2. The E-gas module 3 is subsequently displaced in the direction of arrow P until the foot 8 comes into the meshing area 16. The groove opening 19 of the meshing area 16 is narrower than the groove opening 18, and the groove 6 has two undercuts 20 in the meshing area 16, the undercuts meshing with meshing projections 21 provided at the foot 8. The foot 8 and the meshing area 16 have a T-shaped cross section, and the plane of symmetry S of this T-profile preferably lies in plane G and extends at right angles to the straight line 12.

Furthermore, the groove 7 has undercuts 26 and the foot 9 has meshing projections, which mesh with the undercuts 26, the groove 7 and the foot 9 having an essentially T-shaped cross-sectional profile. The plane of symmetry S of this T-profile preferably lies on the straight line G and extends at right angles to the straight line 12.

The groove 7 is closed on its front side 22 facing the groove 6, so that the front side 22 forms a stop for the foot 9 when the E-gas module 3 is displaced in the direction of arrow P, the foot 9 being in contact with the stop in the completely mounted state of the E-gas module 3. Furthermore, the E-gas module 3 is reliably prevented from separating from the pedal block 2 in the direction opposite the direction of arrow P by the snap hook 14 meshing with the recess 15. Removal of the E-gas module 3 by displacement in the direction opposite the direction of P is possible only by disengaging the snap hook 14 from the recess 15, the disengagement being brought about by lifting the snap hook 14 in the direction of arrow R.

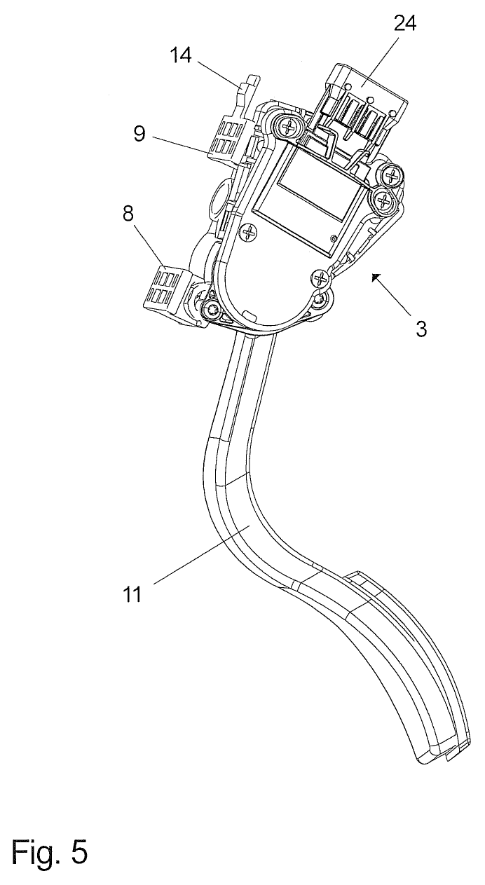

The pedal 11 can be pivoted about the pivot axis 12 relative to the housing 10 and to the pedal block 2 within predetermined limits in the direction of arrow Q and in the direction opposite arrow Q, the sensor 23 shown in FIG. 3 being able to determine the pivot angle of the pedal 11 and to send it as an electronic signal to a control device 34. As is shown in FIG. 5, a plug socket 24 is fastened for this purpose to the E-gas module 3.

As is indicated by broken lines in FIG. 2, the pedal block 2 is fastened to the vehicle body 32 of a motor vehicle 33, in which the control device 34 connected electrically to the E-gas module 3 and to the sensor 23 is arranged as well.

FIG. 6 shows a perspective partial view of the pedal block 2 without E-gas module, so that the shape of the grooves 6 and 7 becomes clear. In particular, the insertion area 17 has no undercuts, whereas the undercuts 20 in the meshing area 16 are defined by projections 25, which limit the groove opening 19. Furthermore, the undercuts 26 of the groove 7 are defined by projections 27, which limit the groove opening 31 of the groove 7.

FIG. 6 also shows that the recess 15 is provided in a support area 28, which is made in one piece with the pedal block 2 and on which the foot 9 lies when the foot 8 is seated in the insertion area 17 before the E-gas module 3 is caused to mesh with the pedal block 2 in a positive-locking manner by displacement in the direction of arrow P. The support area 28 thus acts as a mounting aid.

The E-gas module 3 according to the present invention can be detachably fastened to the pedal block 2 in a simple manner, without additional fastening means, such as screws, bolts, bushings or nuts being necessary. Furthermore, the E-gas module 3 can be completely preassembled before it is fastened to the pedal block 2, which facilitates mounting and increases the number of possible variants, because different E-gas modules can be mounted on different pedal blocks when the plug-in connection is standard.

While specific embodiments of the invention have been shown and described in detail to illustrate the application of the principles of the invention, it will be understood that the invention may be embodied otherwise without departing from such principles.

1-16. (canceled)

17. A pedal arrangement for a motor vehicle, the pedal arrangement comprising:
a bracket;
an E-gas module, said E-gas module forming a structural unit that is independent from said bracket;
a plug-in connection defined by said bracket and said E-gas module, said E-gas module being fastened to said bracket via said plug in connection;
a gas pedal;
a pedal bearing formed as part of said E-gas module, said gas pedal being mounted pivotably to said pedal bearing about a pivot axis.

18. A pedal arrangement in accordance with claim 17, further comprising a snap-in connection, wherein said E-gas module and said bracket are additionally connected to one another via a snap-in connection.

19. A pedal arrangement in accordance with claim 17, wherein said plug-in connection has a first holding groove and a plug having a first foot plugged into same, said plug having a contour meshing with a contour of said first holding groove in a positive-locking manner.

20. A pedal arrangement in accordance with claim 19, wherein said first holding groove extends in parallel to said pivot axis and said first foot is pushed into said first holding groove in a direction in parallel to said pivot axis.

21. A pedal arrangement in accordance with claim 19, wherein said first holding groove extends at right angles to said pivot axis and said first foot is pushed into said first holding groove in a direction at right angles to said pivot axis.

22. A pedal arrangement in accordance with claim 19, wherein said first holding groove has a insertion area as well as a meshing area with an undercut, said undercut being in meshed engagement with a projection provided at said first foot, a width of a groove opening of said insertion area, at right angles to the plug-in direction, being greater than a width of the groove opening of said meshing area, at right angles to the plug-in direction.

23. A pedal arrangement in accordance with claim 22, wherein said meshing area and said insertion area are arranged next to each other in a direction at right angles to said pivot axis.

24. A pedal arrangement in accordance with claim 19, wherein said first foot is provided at said E-gas module and said first holding groove is provided at said bracket.

25. A pedal arrangement in accordance with claim 19, wherein the plug-in connection has a second holding groove at a spaced location from said first holding groove and a second foot is plugged into said second holding groove and meshes with same in a positive-locking manner, at a spaced location from said first foot.

26. A pedal arrangement in accordance with claim 25, wherein said second holding groove extends at right angles to said pivot axis and said second foot is plugged into said second holding groove at right angles to said pivot axis.

27. A pedal arrangement in accordance with claim 25, wherein said first holding groove and said second holding groove lie on a common straight line.

28. A pedal arrangement in accordance with one of the claim 25, wherein said second holding groove is closed on a front side facing said first holding groove and a direction of extension of said gas pedal.

29. A pedal arrangement in accordance with one of the claim 25, wherein said two feet are provided at said bracket and said two holding grooves are provide at said E-gas module.

30. A pedal arrangement in accordance with claims 25, wherein said two feet are provided at said E-gas module and said two holding grooves are provided at said bracket.

31. A pedal arrangement in accordance with claim 30, wherein said second foot has a snap hook, which meshes with a recess provided in said bracket.

32. A motor vehicle with a pedal arrangement, comprising:
a vehicle body;
a bracket, said bracket being fastened to said vehicle body;
an E-gas module, said E-gas module forming a structural unit that is independent from said bracket,
a plug-in connection defined by said bracket and said E-gas module, said E-gas module being fastened to said bracket via said plug in connection;
a pedal;
a pedal bearing formed as part of said E-gas module, said pedal being mounted pivotably to said pedal bearing about a pivot axis.

33. A pedal arrangement in accordance with claim 17, wherein said E-gas module includes a sensor for detecting pivoting motions of said gas pedal relative to the bracket and the pedal bearing and a plug/socket connected to the vehicle for sending an electrical signal representing the pivoting motions.

34. A pedal arrangement in accordance with claim 33, further comprising a snap-in connection, wherein said E-gas module and said bracket are additionally connected to one another via a snap-in connection.

35. A pedal arrangement in accordance with claim 34, wherein said plug-in connection has a first holding groove and a plug having a first foot plugged into same, said plug having a contour meshing with a contour of said first holding groove in a positive-locking manner.

36. A pedal arrangement in accordance with claim 35, wherein said first holding groove has a insertion area as well as a meshing area with an undercut, said undercut being in meshed engagement with a projection provided at said first foot, a width of a groove opening of said insertion area, at right angles to the plug-in direction, being greater than a width of the groove opening of said meshing area, at right angles to the plug-in direction.
